(19) United States
(12) Patent Application Publication
(10) Pub. No.: US 2026/0004599 A1
(43) Pub. Date: Jan. 1, 2026

(54) DOCUMENT IMAGE FORGERY AND INTEGRITY DETECTION USING GENERATIVE ARTIFICIAL INTELLIGENCE

(71) Applicant: PAYPAL, INC., San Jose, CA (US)

(72) Inventors: Vipul Jain, Singapore (SG); Sreeram Vasudevan, Singapore (SG); Li Hua Lim, Singapore (SG); Tamil Mani Arul, Chennai (IN)

(21) Appl. No.: 18/755,424

(22) Filed: Jun. 26, 2024

(51) Int. Cl. G06V 20/00; G06F 21/60; G06V 10/774; G06V 10/776; G06V 10/82; G06V 30/10; G06V 30/414; G06V 30/418

(52) U.S. Cl. CPC G06V 20/95; G06F 21/602; G06V 10/774; G06V 10/776; G06V 10/82; G06V 30/10; G06V 30/414; G06V 30/418; G06V 2201/10

(57) ABSTRACT

There are provided systems and methods for document image forgery and integration detection using generative artificial intelligence. A service provider, such as an electronic transaction processor for digital transactions, may provide computing services to users, which may be used to engage in interactions with other users and entities including for electronic transaction processing. When utilizing these services, document verification may be required to verify a document. A document may be submitted for document verification, which may be analyzed to determine if the document is forged. To train a machine learning model for document forgery detection a generative adversarial network may be used to generate fake documents of forgeries based on trends in forgeries of real documents. These fake documents may be provided as additional training data to more robustly train a model and keep up on changes in forgery techniques.

### TECHNICAL FIELD

The present application generally relates to image data processing and more particularly to utilizing machine learning (ML) models and neural networks (NNs) for identifying low-quality images and repairing such images for data review and extraction.

### BACKGROUND

In service provider systems, images of documents may be submitted for proof of identification, validity, possession, authentication, and the like, as well as image data extraction, such as user images, text, and the like, for providing computing services to users. The service providers may provide document image submission systems and processes, which allow users to capture an image or the like of a physical document and upload that image for processing. However, processing may take a significant amount of time and results may not be immediately provided to the user where the document may be required to be parsed, processed, and analyzed by the service provider system. Further, document verifications from images may be significantly impacted by forgeries and other fraudulent image alterations, edits, and modifications. As such, it is desirable to provide fast, accurate, and precise image and/or document forgery assessments with integrity and fraud detection in real-time or near real-time for better computing security when evaluating documents.

### BRIEF DESCRIPTION OF THE DRAWINGS

FIG. 1 is a block diagram of a networked system suitable for implementing the processes described herein, according to an embodiment;

FIGS. 2A-2D are exemplary diagrams of processes for training and configuring a generative artificial intelligence (AI) for document forgery detection by a decision engine, according to embodiments;

FIGS. 3A and 3B are exemplary system architectures of a generative AI having one or more neural networks (NNs) for document forgery generation and discrimination, which may be used for training and/or configuring a document forgery detection system, according to an embodiment;

FIG. 4 is a flowchart for document image forgery and integration detection using generative AI, according to embodiments; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for document image forgery and integration detection using generative AI. Systems suitable for practicing methods of the present disclosure are also provided.

In computing systems of service providers, computing services may be used for electronic transaction processing, account creation and management, payment and transfer services, customer relationship management (CRM) systems that provide assistance, reporting, sales, and the like, and other online digital interactions. In this regard, computing services and systems may provide computing services to users through various platforms that may require users to verify their identity, authenticate themselves, validate their information, provide supporting documentation for service provision and/or proof of an event, and/or otherwise submit documents and documentation to the service provider for analysis. Such data may be provided through uploads to different platforms and websites or applications, as well as through communications via an email channel, a digital alert channel, a text message channel, a push notification channel, an instant message channel, or other messaging channel. In this regard, paper or physical documents may be scanned, imaged, or otherwise converted to digital form by user devices, such as mobile phones and cameras. However, documents may be forged and/or their images altered in order to conduct fraud, such as to pass off as other users, provide false user information, or otherwise hide fraudsters' identities and/or misappropriate real users' identities.

Traditional fraudsters have relied on primitive techniques, including digital image editing in image and graphical editor applications, to digitally alter documents. However, more recently, generative AI models may be capable of generating real-looking documents by replacing a few personal details easily. Further, training data sets for verification documents, such as government issued documents (e.g., identification cards, licenses, etc.), are more easily accessible, making it easier to forge documents from a wide base of material. Generative AI videos are also becoming adept at forging and creating videos that may fool video techniques for further verification and fraud prevention, such as by having a user hold a card or write on paper. As such, service providers may require that all documents and their information be verified with issuers and intermediaries. However, this introduces significant delay and cost to calling the issuers and intermediaries systems, application programming interfaces (APIs), and the like for each verification request.

As such, according to various embodiments, a service provider may provide an image forgery evaluation and integrity detection framework to improve detection for image and/or document forgeries generated by generative AI or other fraudulent practices and techniques, thereby improving computing system and data security and reducing fraud and risk in a networked computing environment and during application usage. Forgeries of images of documents, as well as their underlying documents from images and/or document databases, are a common and major problem during document verification. A GAN (Generative Adversarial Network)-based model may be introduced to improve detection of forged or otherwise altered images and/or documents based on inconsistencies in document image, background effects, differences in data, and the like. Through this new model, a fraud detection rate may be improved with more accurate document verification results and less loss or risk of data exposure due to malicious actors and fraudulent parties. The GAN or other generative AI may include a decision engine where overall decisions on forgery and/or integrity of documents and/or images of those documents may be computed and determined. This allows for real-time decisioning on document verification and/or fraud detection, which may be used not only with document verification systems, but also by fraud analysts, investigators, and the like to investigate fraud, detect trends in document forgeries and/or other issues of image integrity, and respond to new fraud patterns and detected frauds and forgeries.

Image verification may be needed before a service provider provides computing services to users, including those computing services associated with electronic transaction processing. For example, an online transaction processor (e.g., PayPal®) may allow merchants, users, and other entities to process transactions, provide payments, transfer funds, or otherwise engage in computing services. In other examples, other service providers may also or instead provide computing services for social networking, microblogging, media sharing, messaging, business and consumer platforms, etc. In order to utilize the computing services of a service provider, an account with the service provider may be established by providing account details, such as a login, password (or other authentication credential, such as a biometric fingerprint, retinal scan, etc.), identification information to establish the account (e.g., personal information for a user, business or merchant information for an entity, or other types of identification information including a name, address, and/or other information), and/or financial information.

All of these interactions may generate and/or process data, which may require verification of documents in possession of users, including text and/or image documents, forms, cards, and the like. In order to provide for document verification and detection of forged documents, the service provider may provide, in one embodiment, an NN or other ML framework implementing NNs and other ML models, techniques, and algorithms for document image data processing (e.g., images, scans, or other captures of different documents including identity documents and the like) through a generative AI. Generative AI algorithms can be used to create new content, such as images, videos, and text. With generative AI, a neural network (NN) or other machine learning or AI model learns from both legitimate and forged documents and eventually generates or determines decisions and other outputs indicating whether there is a prediction of forgery or other issue with or alteration to image integrity. With the GAN described herein, a framework may be established to train and utilize the model for decisions on forgery and/or document integrity from the patterns and characteristics found in the features of the training dataset.

For example, a GAN may generate data that is similar to real data for the purpose of document verification, and therefore may be used to generate fake documents that may appear real or valid, which may assist with training a decision engine for more accurate original document verification and forgery detection. As such, a trained GAN may generate new fake documents from original source images or other captures (e.g., scans, digital forms, etc.) of fake and/or valid documents. Such fake images may correspond to the original images and source data on the document as closely as possible based on training and inferences by the trained generative AI, which allows for robust and comprehensive training for document forgery detection. In one example, the GAN is a deep neural network architecture made up of two networks, a generator and a discriminator. The generator learns to generate plausible data from input data, such as image data or other capture data of documents that are forgeries or have integrity alterations made to conduct fraud or other malicious computing attacks. The discriminator may then learn to distinguish the generator's fake data from real data, such as real images of valid and/or forged documents. The discriminator penalizes the generator for producing implausible results, and therefore allows the generator to improve learning for what would be “real” data or the data that is plausible and what would be a forgery or other alteration or modification to document integrity.

When training begins, the generator may attempt to produce real data of forged documents but may start with initial templates or other sources of valid documents and alter them in a manner that causes those documents to be forged, such as by learning forged techniques, portions, edits, and/or other anomalies that fraudsters have made to other past documents and/or images of documents. The discriminator learns to tell if the data is real or generated by the generator, such as a real forged document or one that has been procedurally generated and does not appear as though it is being presented as a real forged document. As training progresses, the generator gets closer to producing outputs that can fool the discriminator and therefore provide real image data of a forged document. As such, once the generator is well trained (e.g., producing outputs within a threshold accuracy), the discriminator may perform worse at telling the difference between real and fake data from the generator, and the discriminator's accuracy decreases as the generator improves at quality image generation and/or improvement (e.g., images or other data for forged documents). After the training is completed, the generator may then be used to generate the real data and other content plausible for the images of forged documents, which may then be used to train an ML model, NN, or the like of a decision engine for forged document detection. A CycleGAN may be used for model finetuning, which does not require paired training data to further finetune the model with real, original data. CycleGAN may correspond to an image-to-image translation model and process that allows for training of deep convolution NNs for image-to-image translation tasks using mappings between input and output images in unpaired datasets.

The service provider may provide a pipeline for forgery and integrity detection that may include a trend compute, a fake document generator, a document vectorization, a decision engine, and a feedback loop or processor. The trend compute may assign weights based on individual features of documents, such as their likeliness to be altered. The fake document generator may correspond to a generative AI model that generates fake documents after training, where the fake documents act as a comparison benchmark for training a ML model that detects document forgeries and/or forged portions of documents. As such, the fake document generator may correspond to a challenger document creator of the fake document forgeries used for ML model training. The document vectorization converts documents (or images thereof) into a vector and the determines similarities between documents. The decision engine is where the overall decision on forgery and integrity is computed. Finally, the feedback loop may include at least two different types of feedback used to retain and adjust the different ML models and/or NNs. For example, the feedback loop may include first feedback scores that score an input document against an original document and/or document template for forgery detection, where the decision on potential forgery may be recorded against the input document, and second feedback scores on fake document generation that assist the fake document generator with adjusting to the style and processes/data in which the generator generates fake documents (e.g., to have consistent improvement while minimizing loss).

When training begins, trends are determined and assigned to different documents having features used during forgery comparison, determination, and/or computation. Trends may correspond to certain forgery techniques, styles, portions of documents that are forged, types of forgeries, and other trending information regarding forgeries. These may be determined by analyzing current, existing, and/or incoming document forgeries. Further, an image processing process may create vectors and/or scores from the trends for model training. This trend identification may be based on an internal database and new incoming trends in forgeries. The trends may also identify features for the ML models, NNs, or the like. A GAN may include a fake document generator and a fake document discriminator as two adversarial NNs that are trained and used for data and/or feedback for further training and refinement of each NN. For example, the fake document generator may attempt to produce fake but real appearing data by training on real documents to identify features in common with genuine documents, and those that may be manipulated, altered, or otherwise changed with forgeries. The discriminator learns to tell if the document or other data is a forgery or not, which may be used to retrain the generator through feedback. As the generator gets closer to producing output that can fool the discriminator and therefore provide documents and other data appearing to be valid, the discriminator may have a harder time in discriminating genuine documents and forged documents. As such, if the generator's training goes well, the discriminator may perform worse at telling the difference between real and fake documents and other data from the generator, and its accuracy decreases. A loss process using Wasserstein GAN (“WGAN” or a loss measured through Wasserstein distance) may be introduced to reduce or minimize the loss in the generator through noise insertion and the like, including minimizing mode collapse and vanishing gradients.

After the training is completed, the generator of the GAN discussed above may then be used to generate the real data and other content plausible for the documents and/or document forgeries. First, the service provider and/or data scientists may create a data set or argument, which may correspond to image training data having images, content, or other data of forged documents and real documents. These may be used to train the generator, where the generator is trained to identify the forged elements, sections, appearances, or other features on the documents, as well as how those forged features or data for those features may be forged while tricking the discriminator or another system the identifies whether a document appears forged or not. The discriminator provides feedback to the generator so that the generator can create highly believable forgeries that appear real. The generator generates high-quality images or other data of documents and document forgeries, which may be used to train the decision engine to identify real or forged documents.

By integrating this trained generative AI model and NNs into the forgery detection process, the process for forgery detection may be made more efficient, faster, and more accurate in identifying forged documents in production verification systems and/or real-time decision-making by decision engines for risk analysis and fraud detection system (e.g., for forged document detection). This can improve operational efficiency and effectiveness by ensuring submitted documents are real and valid, not having forged portions or faked data. In this manner, the service provider's system for automated image processing may be made more secure by providing improved fraud and forgery detection, which may be done in a more efficient, faster, and more accurate manner through automated generative AI systems that require less monitoring and manual efforts for document verification.

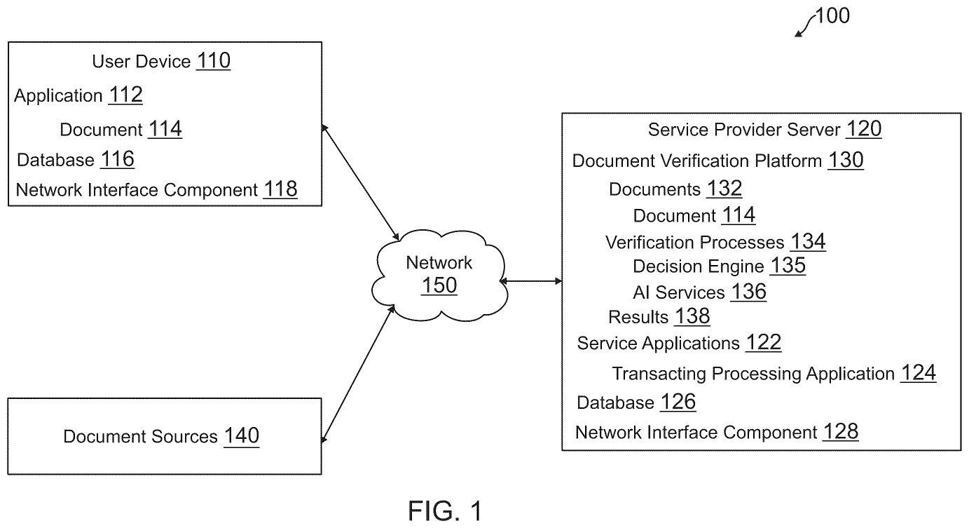

FIG. 1 is a block diagram of a networked system 100 suitable for implementing the processes described herein, according to an embodiment. As shown, system 100 may comprise a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

FIG. 1 provides an overview of system 100 to implement NNs and/or other ML models used for document forgery and integrity analysis and detection. System 100 includes a user device 110, a service provider server 120, and document sources 140 in communication over a network 150. User device 110 may be utilized by a user, customer, or entity to access a computing service or resource provided by service provider server 120, where service provider server 120 may provide various data, operations, and other functions to user device 110 via network 150. In this regard, user device 110 may be used to provide images of documents that are requested to be verified by service provider server 120, which may be real or forged. As such, service provider server 120 may analyze and process such images to determine whether the images include forged documents or images of documents and/or forged portions of those documents and/or images.

User device 110, service provider server 120, and document sources 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

User device 110 may be implemented as a communication device that may utilize appropriate hardware and software configured for wired and/or wireless communication with service provider server 120 and other devices and/or servers. For example, in one embodiment, user device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

User device 110 of FIG. 1 contains an application 112, a database 116, and a network interface component 118. Application 112 may correspond to executable processes, procedures, and/or applications with associated hardware. In other embodiments, user device 110 may include additional or different modules having specialized hardware and/or software as required.

Application 112 may correspond to one or more processes to execute modules and associated devices of user device 110 to provide a convenient interface to permit a user for user device 110 to utilize services of service provider server 120, including computing services that may include providing and submitting documents for verification via images or other digital copies, as well as responding to document image assessments for fraud and/or forgery. Where service provider server 120 may correspond to an online transaction processor, the computing services may include those to enter, view, and/or process transactions, onboard and/or use digital accounts, and the like, which may include providing, verifying, and/or validating documents and other content captured in images by user device 110 and transmitted to service provider server 120. Such images may be provided when engaging in, as well as before or after and in support of, electronic transaction processing or other computing services associated with digital payment accounts, transactions, payments, and/or transfers.

In this regard, application 112 may correspond to specialized hardware and/or software utilized by user device 110 that may provide transaction processing and other computing service usage through a user interface enabling the user to enter and/or view data, input, interactions, and the like for processing. This may be based on a transaction generated by application 112 using a merchant website or seller interaction, or by performing peer-to-peer transfers and payments with merchants and sellers. Application 112 may be associated with account information, user financial information, and/or transaction histories. However, in further embodiments, different services may be provided via application 112, including messaging, social networking, media posting or sharing, microblogging, data browsing and searching, online shopping, and other services available through service provider server 120. Thus, application 112 may also correspond to different service applications and the like that are associated with service provider server 120.

In this regard, when providing document images and other images of objects for verification and approval, application 112 may capture an image, scan, or other data for a document 114, and transmit that data for document 114 to service provider server 120. Document 114 may correspond to a physical or digital document having text, graphics, images, visual content, and the like, which may be processed to determine whether document 114 may be forged or include one or more forged portions, as discussed herein. Service provider server 120 may receive document 114 with other document submission(s) and/or verification(s) and may process document 114 to determine whether the underlying document and data can be verified or may be forged, as discussed herein.

Application 112 may include processes to capture, load, and/or provide document images, scans, or other captures for processing by service provider server 120, as well as output decisions on document forgery, integrity, and/or verification. In various embodiments, application 112 may correspond to a general browser application configured to retrieve, present, and communicate information over the Internet (e.g., utilize resources on the World Wide Web) or a private network. For example, application 112 may provide a web browser, which may send and receive information over network 150, including retrieving website information, presenting the website information to the user, and/or communicating information to the website. However, in other embodiments, application 112 may include a dedicated software application of service provider server 120 or other entity (e.g., a merchant) resident on user device 110 (e.g., a mobile application on a mobile device) that is displayable by a graphical user interface (GUI) associated with application 112.

User device 110 may further include database 116 stored on a transitory and/or non-transitory memory of user device 110, which may store various applications and data and be utilized during execution of various modules of user device 110. Database 116 may include, for example, identifiers such as operating system registry entries, cookies associated with application 112, identifiers associated with hardware of user device 110, or other appropriate identifiers, such as identifiers used for payment/user/device authentication or identification, which may be communicated as identifying the user/user device 110 to service provider server 120. Moreover, database 116 may include document 114, information associated with capturing, scanning, or obtaining data of document 114, and/or results of document 114 processing and verification (which may include forgery detection and integrity analysis), which may be presented and/or output via application 112.

User device 110 includes at least one network interface component 118 adapted to communicate with other computing devices, servers, service provider server 120, and/or document sources 140. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service provider server 120 may be maintained, for example, by an online service provider, which may provide computing services, including electronic transaction processing, via network 150. In this regard, service provider server 120 includes one or more processing applications which may be configured to interact with user device 110 to provide data, user interfaces, platforms, operations, and the like for the computing services to user device 110, as well as facilitate document image analysis for integrity and forgery detection, including generative AI systems and models. In one example, service provider server 120 may be provided by PAYPAL®, Inc. of San Jose, CA, USA. However, in other embodiments, service provider server 120 may be maintained by or include another type of service provider.

Service provider server 120 of FIG. 1 includes a document verification platform 130, service applications 122, a database 126, and a network interface component 128. Document verification platform 130 and service applications 122 may correspond to executable processes, procedures, and/or applications with associated hardware. In other embodiments, service provider server 120 may include additional or different modules having specialized hardware and/or software as required.

Document verification platform 130 may correspond to one or more processes to execute modules and associated specialized hardware of service provider server 120 to provide a platform for analysis of documents 132 including document 114 from user device 110. As such, document verification platform 130 may determine whether documents 132 have indications of forgery or other integrity issues and questions that may cause failure of a document verification or may indicate that the documents are fake and/or being used to conduct fraud. In this regard, document verification platform 130 may correspond to specialized hardware and/or software used by service provider server 120 to process documents 132, such as from a document verification request that may occur during use of service applications 122 and/or transaction processing or identity verification required by transaction processing application 124 of service applications 122. Such request and/or verification may be generated to verify documents and/or content in documents from use of service applications 122. This may be done using an NN or other ML model pipeline and engine that processes documents 132 for content, data, and the like in captured documents or other content using an object detection NN and/or object classification NN that performs forgery detection by identifying and/or classifying areas or portions of documents that may include text, images, graphics, or other data that may be forged when malicious users use such documents for fraud or other attacks on document integrity and/or verification. In this regard, document verification platform 130 may interact with service application 122 to receive, detect, collect, and/or otherwise determine that documents 132 have been provided for verification through the document verification requests from a corresponding domain, category, communication channel, or the like. The document verification requests may be provided during use of a computing service and/or after in conjunction with use, such as to provide a service to users through service applications 122.

In various embodiments, document verification platform 130 includes NNs and ML models that may be used for intelligent decision-making and/or predictive outputs and services, such as during the course of performing integrity checks on documents submitted for document verification and/or identifying forged documents that have been submitted, analyzed, and/or requested to be verified. Verification processes 134 may include a decision engine 135 that may provide a predictive output, such as a score, likelihood, probability, or decision, associated with assessment of documents 132 for verifying or declining to verify documents 132. When verifying images or other data for documents 132, AI services 136 may be used, which may include NNs for fake or challenger document generation through a GAN or other adversarial NN and/or generative AI. In some embodiments, AI services 136 may include generator NNs and discriminator NNs that generate these fake or challenger forged documents for model and/or network training using a GAN, CycleGAN, or other generative AI trained on legitimate documents, templates of legitimate documents, and the like, as well as forged documents, trends in document forgeries, forged document portions or other indicators, and the like. Using the legitimate, forged, and/or procedurally generated forged documents (e.g., fake or challenger documents generated by the generator), another NN or ML model may be trained for document forgery detection and integrity analysis. As such, AI services 136 may employ a combination of different NNs and ML model algorithms including deep NNs, algorithms, and techniques for object location and classification, as well as image data extraction and analysis. Although NN algorithms are discussed herein, it is understood other types of computing systems and models, including NNs, ML models, and AI-driven engines and corresponding algorithms, may also be used.

For example, AI services 136 of document verification platform 130 may include NNs trained for intelligent decision-making and/or predictive outputs (e.g., scoring, comparisons, predictions, decisions, classifications, and the like) for particular uses with computing services provided by service provider server 120 for document or user verification. When generating NNs, NN algorithms and trainers may be used to create NNs, and training data may be processed to generate one or more classifiers that provide recommendations, predictions, or other outputs based on those classifications and NN algorithms. Service provider server 120 may implement one or more NN algorithms to generate different object detection and classification NNs and NN task performances, as well as procedurally generate new, fake, and/or challenger documents, images or scans of documents, or other data that may be used during model or network training of an ML model, NN, or the like for forgery detection or other document verification task.

When initially configuring NNs using corresponding algorithms, training data may be used to determine input features and utilize those features to generate NN architectures and corresponding NN outputs at an output layer. For example, NNs may include multiple layers, including an input layer, a hidden layer, and an output layer having one or more nodes, however, different layers may also be utilized. As many hidden layers as necessary or appropriate may be utilized. Each node within a layer is connected to a node within an adjacent layer, where a set of input values may be used to generate one or more output values or classifications. Within the input layer, each node may correspond to a distinct attribute or input data type that is used by the NN algorithms using feature or attribute extraction for input data.

Thereafter, the hidden layers may be generated with these attributes and corresponding weights using an NN algorithm, computation, and/or technique. For example, each of the nodes in the hidden layers generates a representation, which may include a mathematical ML computation (or algorithm) that produces a value based on the input values of the input nodes. The ML algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node to produce one or more output values for the ML models that provide an output, classification, prediction, or the like. Thus, when the ML models are used to perform a predictive analysis and output, the input may provide a corresponding output based on the classifications trained for the ML models. As many hidden layers and nodes as necessary may be provided and trained, where each hidden layer is interconnected to the previous and next hidden layer and hidden layers are further interconnected to the input layer and output layer, creating a set of neurons of the NNs.

By providing input data, the nodes in the hidden layers may be adjusted such that an optimal output (e.g., a classification) is produced in the output layer. By continuously providing different sets of data and penalizing NNs when the outputs of the NNs are incorrect, the NN algorithms for document verification platform 130 (and specifically, the representations of the nodes in the hidden layers) may be adjusted to improve their performance in data classification. This data classification may correspond to object detection, extraction, and processing by AI services 136 for image verifications and the like for document integrity analysis and/or forgery detection. However, other NNs may correspond to generative AIs where their corresponding outputs may correspond to intelligently and/or procedurally generate data, such as fake or challenger documents used to train the ML model of AI services 136 for document forgery detection and integrity analysis. Using the NN algorithms, AI services 136 may be created to perform intelligent decision-making and predictive outputs.

Thus, images, scans, or other data of documents 132 may be processed, scored, and/or verified in response to document verification requests from service applications 122. The image data for documents 132 may be filtered by document verification platform 130 and preprocessed, such as to provide general image cleansing, filtering noise, and the like. Further, document verification platform 130 may perform data preprocessing in order prepare the image data for object detection and classification during forgery analysis. Document verification platform 130 may execute a ML model for object detection, data extraction, and/or document verification of document data detected in documents 132. Image processing NN 133 may be trained using past images, scans, and the like of documents so that document verifications may be performed by analyzing whether portions or data on documents is forged or appears forged, such as based on scores, predictions, thresholds, and the like of forgery likelihood in extracted data. During the scoring, an object classification NN may attempt to classify a likelihood of a document being forged or having a portion that appears forged, which may be used to verify a valid or legitimate document or decline a verification of a potentially forged document.

Document verification platform 130 may then output image verifications and/or other data associated with image verifications to user device 110 and/or another endpoint, application, or the like of service applications 122 requesting the document verification. For example, image verifications may correspond to those ones of documents 132 that may be approved for document image processing, verification, and/or data extraction (e.g., approved and/or validated for data, approved for using OCR or the like to extract image data, etc.). However, verification failures may indicate those ones of documents 132 may instead be forged and/or being used to conduct fraud. When training this ML model of AI services 136, a GAN, deep convolution NN, or other generative AI may be trained and used to generate images, scans, or other data of forged documents in a procedural manner such that the fake forged documents may be used as challenger data and documents to the ML model during training and to identify new and/or different forgeries or potential forgeries, thereby providing training on trends or variations of document forgeries and forgery techniques. This may employ generator NNs in a GAN that may generate the forged documents using trends detected from a trend compute in forgeries, where the trend compute may assign weights to different features on documents based on their likeliness to be altered. The generator may correspond to a generative AI that may generate fake documents of forgeries (as well as valid documents, when requested), receive feedback from a discriminator NN, and refine or retrain fake document generation. Discriminators may correspond to deep NNs trained to distinguish between fake and real documents, and provide feedback to the generator on whether the fake documents appear as real forgeries, are plausible or capable of being forged documents (or valid documents, when requested), and retrain the generator for better fake document generation.

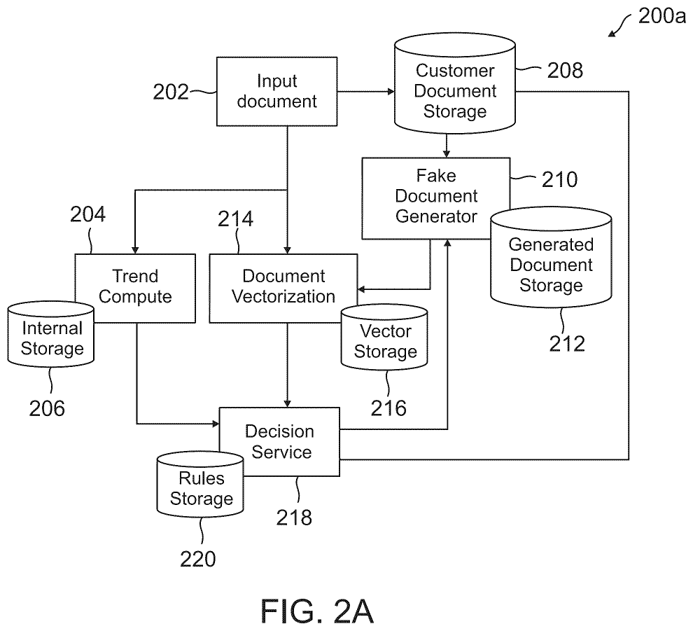

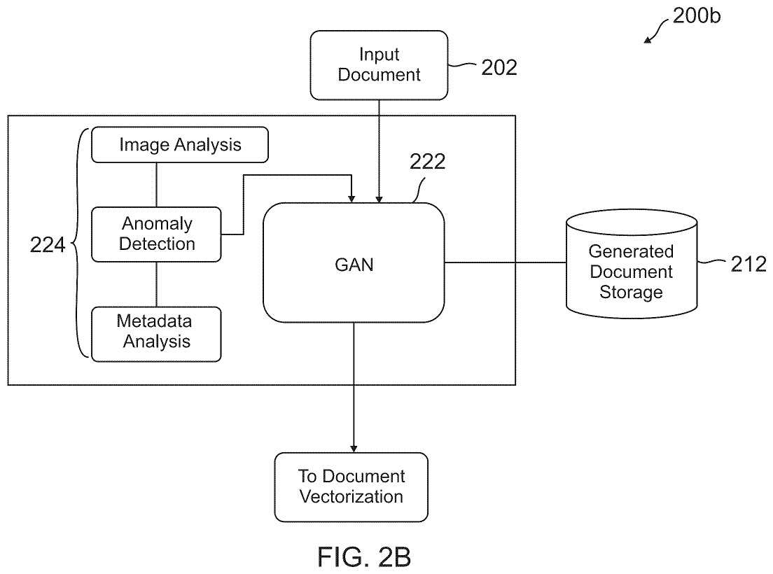

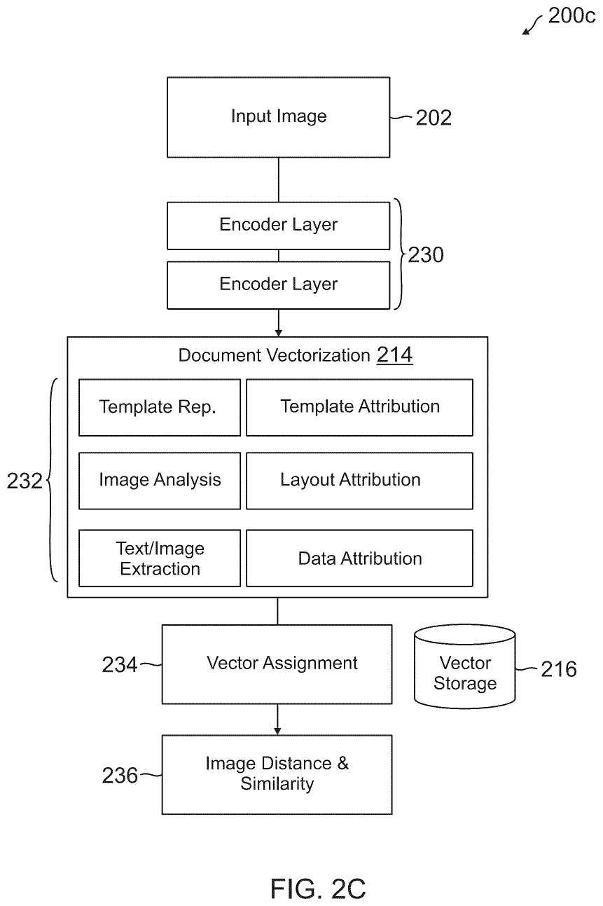

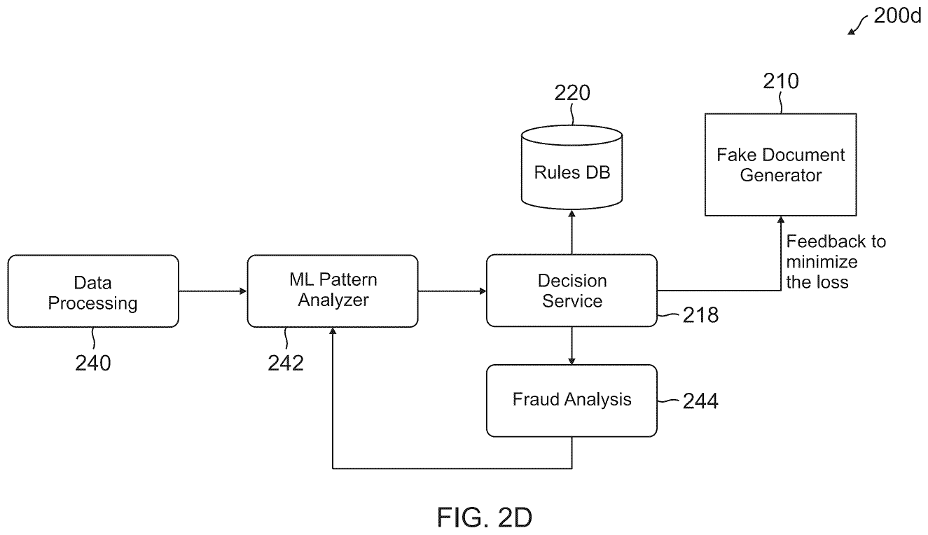

As such, generators may be used to generate image data with discriminators used to distinguish and discriminate between the image data of different quality. This allows for training of a generator and discriminator to generate fake documents and identify differences and loss between fake and real documents regarding whether the generator has performed adequately. Training may be done based on documents and document templates, where a document vectorization process and module may convert input images, scans, or other data of documents to vectors for vector training and analysis by ML, NN, or other AI algorithms and training techniques. Decision engine 135 may therefore deploy AI services 136 during decision-making and outputs, such as document forgery analysis. The training and use of GANs and ML models for document forgery detection is discussed in further detail below with regard to FIGS. 2A-4.

Service applications 122 may correspond to one or more processes to execute modules and associated specialized hardware of service provider server 120 to process a transaction or provide another service to customers or end users of service provider server 120. For example, service applications 122 may include a transaction processing application 124 and may correspond to specialized hardware and/or software used by service provider server 120 to providing computing services to users, which may include electronic transaction processing and/or other computing services provided by service provider server 120, such as in response to receiving transaction data for electronic transaction processing of transactions initiated using digital wallets. In some embodiments, transaction processing application 124 of service applications 122 may be used by users, such as a user associated with user device 110, to establish user and/or payment accounts, as well as digital wallets, which may be used to process transactions. Accounts may be accessed and/or used through one or more instances of a web browser application and/or dedicated software application executed by user device 110 and engage in computing services provided by service applications 122.

In various embodiments, financial information may be stored to the account, such as account/card numbers and information. A digital token for the account/wallet may be used to send and process payments, for example, through an interface provided by service applications 122 and/or transaction processing application 124. The payment account may be accessed and/or used through a browser application and/or dedicated payment application executed by user device 110 and engage in transaction processing through service applications 122 and/or transaction processing application 124. Transaction processing application 124 may process the payment and may provide a transaction history to user device 110 for transaction authorization, approval, or denial. In other embodiments, service applications 122 may instead provide different computing services, including social networking, microblogging, media sharing, messaging, business and consumer platforms, etc. Such services may be utilized through user accounts, websites, software applications, and other interaction sources, which may request document verification to allow, enable, or provide certain computing services, verify users, and the like through document verification requests.

Service applications 122 may also provide additional features to service provider server 120 and/or user device 110. For example, service applications 122 may include security applications for implementing server-side security features, programmatic client applications for interfacing with appropriate application programming interfaces (APIs) over network 150, or other types of applications. Service applications 122 may contain software programs, executable by a processor, including one or more GUIs and the like, configured to provide an interface to the user when accessing service provider server 120, where the user or other users may interact with the GUI to more easily view and communicate information. In various embodiments, service applications 122 may include additional connection and/or communication applications, which may be utilized to communicate information to over network 150.

Additionally, service provider server 120 includes database 126. Database 126 may store various identifiers associated with user device 110. Database 126 may also store account data, including payment instruments and authentication credentials, as well as transaction processing histories and data for processed transactions. Database 126 may store financial information and tokenization data, as well as transactions, transaction results, and other data generated and stored by service applications 122. Further, database 126 may include data provided for document verification requests, including documents 132 having documents 114 from user device 110.

In various embodiments, service provider server 120 includes at least one network interface component 128 adapted to communicate with user device 110, document sources 140, and/or other computing devices and servers directly and/or over network 150. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Document sources 140 may correspond to different online websites, databases, devices, endpoints, and the like where documents and/or templates for documents may be received, which may correspond to training data used for training of one or more ML models, NNs, or the like of service provider server 120 for document forgery and integrity analysis and detection. In this regard, document sources 140 may provide source documents and/or templates for legitimate documents, such as sources of identity cards, passports, drivers licenses, birth records, citizenship records, and the like. Document sources 140 may be accessed and/or queried by service provider server 120 when training such ML models, NNs, and the like for document forgery detection and/or integrity analysis. In some embodiments, document sources 140 may further provide forged documents and/or information regarding trends in forging documents, such as samples of forged documents and/or forged portions of documents locations of forgeries on documents, or other labeled data associated with forged documents and forgeries or integrity issues on documents that may have failed verifications, were used in conducting fraud, or the like.

Network 150 may be implemented as a single network or a combination of multiple networks. For example, in various embodiments, network 150 may include the Internet or one or more intranets, landline networks, wireless networks, and/or other appropriate types of networks. Network 150 may correspond to small scale communication networks, such as a private or local area network, or a larger scale network, such as a wide area network or the Internet, accessible by the various components of system 100.

FIGS. 2A-2D are exemplary diagrams 200a-200d of processes and components for training and configuring a generative AI for document forgery detection by a decision engine, according to embodiments. Diagrams 200a-200d of FIGS. 2A-2D show exemplary training data, training, and utilization of a GAN or other generative AI for creation of a generator NN that generates fake or challenger documents or data for forged documents that may be used to train a ML model for forgery detection. In this regard, diagrams 200a-200d show data, components, and processes that may be included on or executed by document verification platform 130 of service provider server 120 from system 100 of FIG. 1.

Referring now to FIG. 2A, in diagram 200a, exemplary components interacting in a system to train a generator NN for fake document generation of forged documents based on trends in forgers are shown. In this regard, a system may be trained and configured to look for inconsistencies in document images, scans, or other data for exposure, misalignment, offset, pixel adjustment, text changes or adjustment, and the like that may indicate forgeries. The quality of the image may be important because without a clear image, it may be hard to make out security features. As such, an input document 202 may be received and first processed to determine if input document 202 is of sufficient quality to be processed. This may utilize an image processing AI system and/or model that may identify whether there are any image quality or clarity issues and whether input document 202 may be processed. If of sufficient quality, input document 202 may then be processed.

Initially during training of an ML model to identify forged documents and a GAN to generate fake forged documents for ML model training, a trend compute 204 may be executed to identify trends in forged documents. For example, a background for a passport may have differences in data when forged that lead to pointers indicating that the document is forged. Trend compute 204 may assign weights based on individual features of documents, for example, a likeliness of those individual features to be altered. In this regard, trend compute 204 may receive a set of annotated documents of forgeries that indicate the portions forged, as well as any other annotations of the documents, such as how the documents were forged, and what type of forgery occurred (e.g., image replacement, digital pixel or text changes, etc.). Trend compute 204 may then identify and determine trends from this data, which may be done by a ML model and engine to extract data, vectors, and/or features, for the same or similar forgeries and generate forgery trends. An internal storage 206 may be used to store the trends determined from trend compute 204. Internal storage 206 may be accessible by the other components of diagram 200a thereafter during ML model, GAN, NN, or other AI system training. Input document 202 may also be stored by a customer document storage 208, such as a database that may store different data for documents including the images, scans, or the like of documents that have been uploaded and/or otherwise provided by users.

A fake document generator 210 may be trained based on trends from trend compute 204, such as by accessing trends over a time period from internal storage 206, as well as customer document storage 208 and other sources of fake and/or real documents including templates of documents used for identity or other verification purposes. Fake document generator 210 may correspond to a generative AI-based generator, such as a generator NN, that may act as a source of comparison benchmarks and challenger documents for ML model training for forgery detection. Fake document generator 210 is described in further detail below with regard to FIG. 2B. The outputs of fake document generator 210 may then be stored to a generated document storage 212, which may correspond to a database that may store procedurally generated images, scans, or other data for the fake documents of the forgeries.

Thereafter, a document vectorization 214 may be performed. Document vectorization 214 may correspond to a step to convert documents into vectors in order to determine the similarity between different documents. Document vectorization 214 is described in further detail below with regard to FIG. 2C. A vector storage 216 may be used to store vectors of documents and/or document data based on their features and other extracted data when converted to vector form (e.g., a mathematical representation of the document or document image, scan, or the like, which may have n-dimensionality based on n features and/or after dimensionality reduction of n features). The vectors may then be provided to a decision service 218, which may determine decisions on forged document and integrity analysis, as well as execute actions with document forgery determinations (e.g., verification of non-forged documents, declination to verify, request for resubmission, etc.). Decision service 218 may correspond to a component where the overall decision of forgery and integrity is computed and determined. This may be provided to a corresponding application and/or computing service for document verification or other steps. Such decisions may be based on rules from a rules storage 220, such as thresholds and other rules for forgery detection based on similarities between forged documents and/or vectors of forged documents and received documents for analysis. There may also be feedback provided for the original document, such as whether input document 202 is forged or valid, as well as to fake document generator 210. The latter of this feedback to fake document generator 210 may be used to help fake document generator 210 to adjust the style and manner in which fake documents of forgeries are generated (e.g., to provide improvements on forgery identification through additional forgery training data generation and trend updates, as well as minimize loss).

In FIG. 2B, diagram 200b shows a representation of a GAN 222 that may be trained and configured for fake forgery document generation, which may be used to provide procedurally generated inputs of forged documents for ML model training of an ML model that identifies forged documents. This allows for staying up-to-date on trends and changes in forgeries as fraudsters change their tactics, styles, and techniques for forging documents. In this regard, trends used for GAN training of GAN 222 may be based on document feature weights during forgery computation. For example, some features of the documents are easier to forge so less weights will be placed on them, for example, the name in the passport, while others, such as a hologram sticker, are harder to forge, so more weight may be assigned. Computation of trends may examine trends of the features. Format checking may be performed, such as by checking the data of a certain format, if nearby pixels are noisy or not (e.g., noise analysis in images). An internal database may be used to scan metadata information and check if the metadata for an image is correlated with or matches the same phone, tool, or channel where the document is being submitted (e.g., captured and/or submitted using a smart phone). Further, analysis of the user may be performed to detect if the user is likely to forge documents based on their location, actions, past history, requests for verification, and the like.

In some embodiments, forensic software may be used to capture modified metadata of documents and translate the metadata to a forger, such as by comparing a master file table on the creation of a document to different components that are expected for document creation. The creation time for the master file table should roughly equate to the time of the actual upload or it may indicate that the file was captured earlier or misappropriated from another user, device, or the like. A hash compute of the metadata may also be used for trends, such as by splitting images into a set of pieces (e.g., 16 or 32 pieces), and hashing each piece. These hashes may then be compared with similar images to determine if similarities in document forgeries exist by copying other documents where other portions of the document may have been adjusted or changed. This may be used to identify image pixel variations due to light exposure and the light. Vectorization of images and/or data in images may also be used for comparisons and therefore may be included with trends, such as vectors for changes to colors, size, resolution, background positioning, etc.

As such, trends may be used for input when training GAN 222 with input document 202 and/or other training data, which may allow for configuring of fake document generator 210 for fake document generation. Fake document generator 210 may correspond to a portion of GAN 222 that generates fake documents that allows for identifying forged documents and checking the integrity of the document using generative AI. For example, forged document identification may include analyzing the document's content, structure and features to detect inconsistencies or patterns indicative of forgery. In this regard, generative AI may be used for training GAN 222 based on analytics 224, such as image analysis, anomaly detection, and/or metadata analysis. With anomaly detection, when training GAN 222, a generative AI model may be trained on a dataset of legitimate documents. The model may learn typical patterns and structures of authentic documents. When presented with a new document, the AI can detect anomalies or deviations from the learned patterns, which may indicate forgery. With anomaly detection for analytics 224, generative AI models may be trained to identify alterations, inconsistencies, or anomalies in images that may indicate forgery. Generative AI models may also be trained for metadata analysis to identify discrepancies or inconsistencies with metadata. As such, the training for GAN 222 based on analytics 224 from generative AIs may be based on trends, input documents and/or document templates, and the like.

GAN 222 may include a generator NN and a discriminator NN, where the generator NN may be used for fake document generation (e.g., fake document generator 210) and output to generated document storage 212, as well as document vectorization for document vector generation. When beginning training a generator in diagram 200b with a discriminator for GAN 222, the generator produces an apparent fake document image of a forgery, and the discriminator may quickly learn to tell that this is a fake document and not real, such as by matching to the real document forgeries, as well as templates or other data of real documents. However, as training progresses, the generator gets closer to producing an output that can fool the discriminator, i.e., the discriminator determines the output (a fake version of a forged document) is a real high-quality image of a forged document (or any document as required by the training). Finally, when generator training is sufficiently performed to obtain an acceptable document generation performance, the discriminator may perform worse at telling the difference between real and fake document images from the generator of documents including fake or challenger forged documents. Thus, the discriminator starts to classify fake document images as real, and the discriminator's accuracy decreases and the accuracy of the generator in producing real appearing and/or high-quality images of fake documents improves.

As such, after training is completed (e.g., accuracy sufficiently improved to generating real-like images, scans, or other data of document forgeries), the generator may be used to generate fake or challenger forged documents from document templates and trends in document forgeries so that those documents may be used for training of an ML model for document forgery detection, thereby providing continuously updated, new, and current document forgeries that may stay ahead of malicious entities attempts to forge documents. The discriminator then provides image feedback, such as loss and image quality and/or accuracy of the generator in recreating or mirroring forged documents. This is then used for improving the generator during retraining and/or tuning. Thus, GAN 222 may be trained on legitimate documents to help recognize features that are common with genuine documents and assess whether features in fake documents as consistent with those genuine documents.

In diagram 200c, input document 202 is processed by document vectorization 214 to determine vectors and perform vector comparisons based on similarity scores between vectors (e.g., Euclidean distance, cosine similarity, etc.). As such, diagram 200c represents the process of converting an image, scan, or other data of a document through different encoder layers in order to reduce the dimensionality of the image (or other data) and create a mathematical representation of the image for image comparisons. Initially, encoder layers 230 encode an image into a vector representation based on values for different features of the vector representation and/or ML model. Encoder layers 230 may perform operations to generate encodings or other representations, which may be done through feature extraction. These encodings may then be provided to document vectorization 214 that may perform vector generation based on vectorization attributions 232 including template attribution, layout attribution, and/or data attribution. In this regard, template attribution may be based on a template repository (e.g., a repository of issue country, date, etc. for different templates of identity documents or other documents). A unique attribute may be assigned to each feature based on the templates and values assigned during template attribution. For layout attribution, orientation, quality, shadow, background, exposure/light, hands/other objects, and the like may all be assigned features for their corresponding document attributes based on the result of image analysis. For data attribution, user data, photos, and/or other printed information may be extracted, and the values of the attributes assigned.

After document vectorization 214 based on vectorization attributions 232, the resulting vector attributions may be provided to a vector assignment 234. During vector assignment 234, for each attribute extracted, a vector dimension is assigned thereby creating a multi-dimensional vector of the entire image. The vectors are then processed using an image distance and similarity 236, where other similar images are calculated, compared, and identified based on the vectors. This may be done through different permutations including based on template and layout similarity, such as identifying N other similar images that assist in identifying a likelihood of fraud from comparisons. The permutations may also be based on data similarity, such as if there at X matching images with a 95% (or other threshold) match, there may be identifications of the same image being altered to conduct fraud through forgery. The resulting vectors and vector comparisons may then be stored to a vector storage 216.

Diagram 200d of FIG. 2D shows operations and components for decision service 218 in further detail. When processing images by decision service 218, a decision on forgery likelihood and/or document verification may be determined. For example, input to decision service 218 may include data from a trend compute system that provides the similarity match percent of the image as output of the document fed from internal database matching. The input may further include input documents and/or other data, where a data processing 240 may be performed to preprocess and prepare the data for an ML pattern analyzer. Data processing 240 to preprocess data may provide consistency and compatibility across different data sources. ML pattern analyzer 242 then provides a support vector machine model or the like with score details for scoring comparisons between data for different documents, trends, and other input data. This may include user data, locations, and/or other attributes input to the system to predict an output on forgery likelihood. Decision service 218 may then process the comparisons by ML pattern analyzer with rules from rules database 220 to check if a threshold is breached and, if so, whether the document should be flagged as fraudulent and an action taken (e.g., manual verification by a fraud analyst based on suspicious areas of the potentially forged document). As such, a fraud analysis 244 may be conducted by an internal team member or analyst, or may be performed intelligently based on analysis of identified portions of a document having forgery or integrity flags. The final decision by decision service 218 and/or fraud analysis 244 may be provided back to ML pattern analysis to reward or penalize the ML model. Further, the generator and discriminator for GAN 222, such as fake document generator 210, may also be rewarded or penalized based on this feedback and output in order to generate better quality fake documents for forgery detection. This may assist in minimizing loss by training over time with generated fake documents by fake document generator 210.

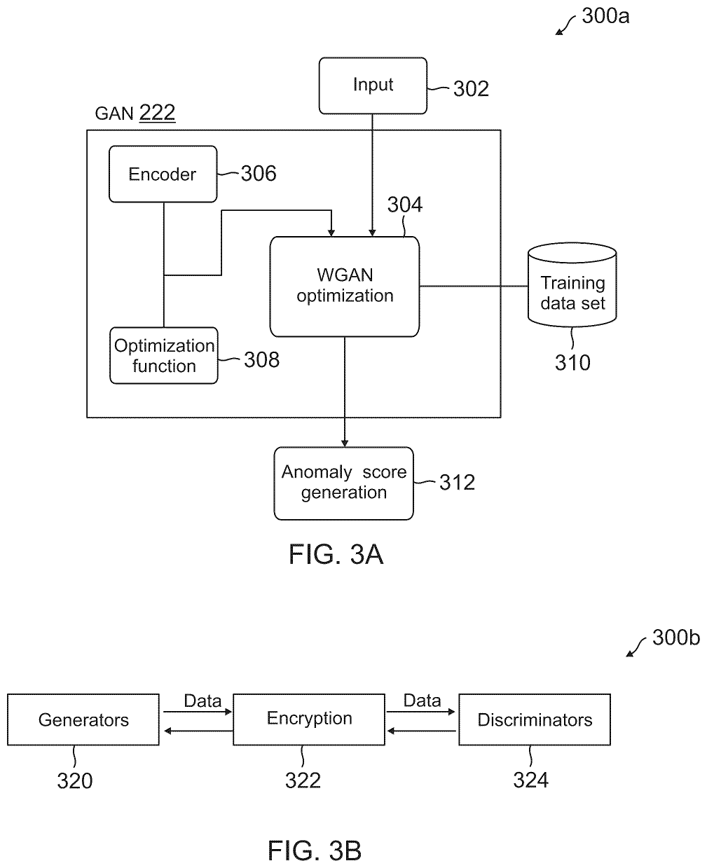

FIGS. 3A and 3B are exemplary system architectures 300a and 300b of a generative AI having one or more NNs for document forgery generation and discrimination, which may be used for training and/or configuring a document forgery detection system, according to an embodiment. System architecture 300a of FIG. 3A includes components of an NN framework that may be used for WGAN optimization through loss minimization. System architecture 300b of FIG. 3B includes components for encrypting fake and/or challenger documents that have been generated by a fake document generator of a GAN so that model training may not be abused and/or interfered with by malicious entities.

In system architecture 300a, GAN 222 is shown processing an input using a WGAN optimization 304, which may be used for minimizing generator loss of the generator for fake documents. In this regard, when creating data close to real documents, it may be important to reduce the noise in the fake data generated. As such, a WGAN network coupled with an encoder 306 that learns during training GAN 222 may be used to speed up the process of training. Input 302 may correspond to a fake document generated by a generator of GAN 222 and may be analyzed to determine loss. This loss analysis may be based on anomaly scores from a training data set 310 and result in anomaly score generation 312. By using this process, issues with mode collapse may be minimized (e.g., the generator produces the most plausible output for the current discriminator), as well as vanishing gradients (e.g., the current discriminator performs significantly better than the generator) may be minimized.

WGAN optimization 304 of input 302 may be based on an encoder 306 and an optimization function 308. In this regard, encoder 306 may be provided to speed up training by breaking down data for documents into discreet values for score calculation. These values may be used with optimization function 308 during score calculation of anomaly scores for anomalous portions of documents indicating fraud. Anomaly score generation 312 therefore provides an output that may be used to configure GAN 222 to prevent issues with confusions during GAN training and feedback processing. As such, WGAN optimization 304 may reduce issues that may occur with overtraining by identifying the quality of documents and how discriminators are preforming.

System architecture 300b shows a process where GAN and generator training may be secured from outside influence and tampering, which may cause false data to be used for training and/or generators and/or ML models to be trained incorrectly so that forgery detection is not adequately performed. In this regard, GAN generated data from generators 320 may be encrypted using encryption 322, such as an AES 256-bit encryption (including symmetric encryption for processing time considerations). Further, the data may only be allowed to be transferred on the same subnet to monitor for unknown traffic not from generators 320 or discriminators 324. A watermark may also be added to fake or challenger documents that are generated, such as a hash value that may be used to check the integrity of the generated data. The users with access to generators 320 and/or discriminators 324 may be monitored to determine who has accessed the data in case there are abnormal entries or training results, as well as if the GAN generated data is leaked. This may include implementing a policy-based access control to the data. To defend against GAN poisoning, each dataset may be watermarked with an attached has value from generators 320, and discriminators 324 may only analyze the data with the correct hash values.

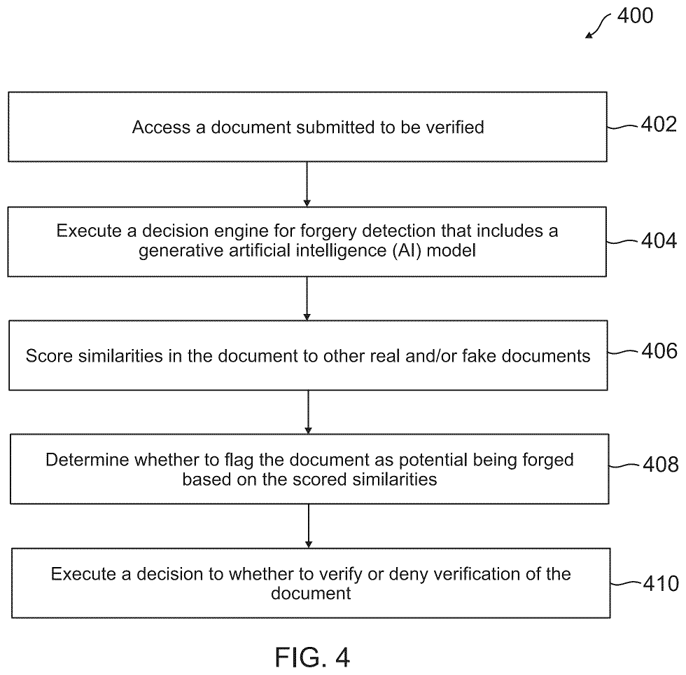

FIG. 4 is a flowchart 400 for document image forgery and integration detection using generative AI with adversarial training, according to embodiments. Note that one or more steps, processes, and methods described herein of flowchart 400 may be omitted, performed in a different sequence, or combined as desired or appropriate. Further note that while flowchart 400 describes an exemplary process for document forgery detection using ML models trained from procedurally generated data from GANs, such steps described herein may be performed with other similar steps and sequences, as those of ordinary skill in the art will recognize.

At step 402 of flowchart 400, a document submitted to be verified is accessed, such as when or after being received from a user device or a user and/or an application during a document verification process or in response to a document verification request. For example, user device 110 may be used to capture an image, scan, or other data of document 114 using application 112, which may be submitted to document verification platform 130 for document verification, such as to use one or more of the services provided via service applications 122. In this regard, the user may be prompted to capture an image of the document, such as by using a mobile smart phone with corresponding digital camera. Once captured, document 114 may be submitted to service provider server 120 for processing.

At step 404, a decision engine for forgery detection that includes a generative AI model is executed. Decision engine 135 may be executed by document verification platform 130 in response to receiving document 114 and/or accessing document 114 from documents 132 for validation and verification, such as to detect whether there are any integrity issues or warnings that may indicate a forgery or fraud in the document. As such, AI services 136 may be utilized, which may include a GAN trained to generate fake documents of challenger or forged documents that may be used to train an ML model on forgery detection, such as based on trends in forgeries and potential forged portions and/or forged techniques (e.g., styles, changed attributes including text, color, or pixels, and the like on documents or in images or scans of documents). For example, GAN 222 may include fake document generator 210 that generates fake documents of forgeries after training using a discriminator to provide feedback to fake document generator 210.

At step 406, similarities in the document to other real and/or fake documents are scored, such as using the decision engine and/or based on outputs of the decision engine. For example, during fraud analysis 244, decision service 218 may provide scores and/or other decisions regarding the similarities of documents, such as based on their vectors or the like that may be determined using document vectorization 214. As such, the similarities may indicate whether there are any forged indications or issues or warnings for document integrity that may indicate forged information in document 114 and/or other fraud. The similarities may be compared based on a threshold and whether the similarities meet or exceed a threshold similarity to indicate that forged data is likely present.

At step 408, it is determined whether to flag the document as potentially being forged based on the scored similarities. Decision engine 135 may, utilizing the similarities, output a decision of forgery likelihood. For example, decision service 218, which may correspond to a microservice or other computing component (e.g., application, executable processes, etc.), may output fraud analysis 244 based on ML pattern analyzer 242 and a corresponding ML model trained for forged document identification using forged documents and the procedurally generated (e.g., fake or challenger) forged documents, as well as valid documents and/or document templates. This may be based on rules, such as threshold for forgery detection when comparing similarities from step 406, from rules database 220.

At step 410, a decision on whether to verify or deny verification of the document is executed. Based on whether document 114 is flagged, document 114 may then have a corresponding action executed. For example, during a document verification request, if document 114 does not have an indication of fraud or forgery and data can be extracted for proper user verification and/or identification, then the document may be verified and may be used with processes of service applications 122 to provide computing services to users. However, if an indication of forgery or other fraud exists, the document verification may be denied and further verification declined with the user. This may include flagging the user and/or account as malicious, requesting resubmission of the document, or otherwise performing a remediation action that may seek to reduce fraud and/or harm caused by the user and/or forged document, prevent fraud, or reverse potentially previously fraudulent actions by the user and/or account.

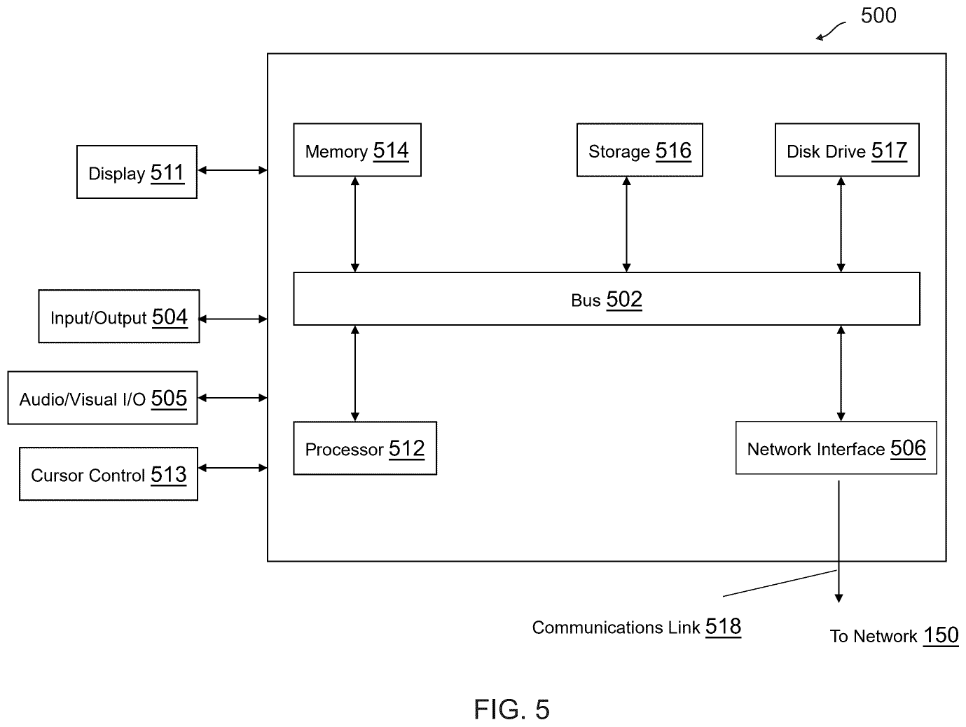

FIG. 5 is a block diagram of a computer system 500 suitable for implementing one or more components in FIG. 1, according to an embodiment. In various embodiments, the user device 110 may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers, including service provider server 140 and document sources 140, may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to execute instructions to cause the system to:
receive a document for a user that is submitted for a document verification of the document;
execute a decision engine for document forgery detection that comprises a generative artificial intelligence (AI) model trained for fake document generation and a machine learning (ML) model trained for fake document identification, wherein the generative AI model includes a generative adversarial network (GAN) that generates fake documents and distinguishes between the fake documents and real documents for the document verification;
score, using the decision engine, similarities of the document to a plurality of preselected documents for the document forgery detection, wherein the plurality of preselected documents are associated with known document formats used for the document verification of documents;
determine, using the decision engine, whether to flag the document as a potentially forged document based on the scored similarities; and
execute a decision on the document verification based on whether the document is flagged as the potentially forged document.

2. The system of claim 1, wherein, prior to determining whether to flag the document using the decision engine, executing the instructions further causes the system to:
determine a trend in forgeries of document features of the plurality of preselected documents based on at least one of an image format or metadata of the image; and
assign one or more weights to one or more of the document features based on the trend in forgeries,
wherein determining whether to flag the document is further based on the one or more weights.

3. The system of claim 1, wherein the decision comprises one of an approval of the document for the document verification, a rejection of the document for the document verification, or a request for resubmission of the document for the document verification, and wherein executing the instructions further causes the system to:
execute an action that comprises one of performing an optical character recognition (OCR) process on the document for data extraction after the approval or transmitting the rejection of the document or the request for resubmission to the user.

4. The system of claim 1, wherein, prior to receiving the document, executing the instructions further causes the system to:
train a generator neural network (NN) and a discriminator NN of the GAN using training data, wherein training the generator NN and the discriminator NN includes:
generating the fake documents using the generator NN,
distinguishing between the fake documents and the real documents using the discriminator NN, and
providing feedback for retraining the generator NN from the discriminator NN based on the distinguishing.

5. The system of claim 4, wherein the training data comprises at least one of legitimate documents or legitimate document templates corresponding to the plurality of preselected documents.

6. The system of claim 1, wherein executing the instructions further causes the system to:
reduce, during training the generator NN and the discriminator NN, noise created in the fake documents by the generator NN using anomaly scores for the fake documents from a GAN optimization network, wherein the anomaly scores are associated with at least one of a quality of the fake documents from the generator NN and a metric indicated a performance of the discriminator NN.

7. The system of claim 4, wherein executing the instructions further causes the system to:
watermark data generated by at least the generator NN;
encrypt the data prior to providing the data at least to the discriminator NN; and
track users and accounts having access to the generator NN and the discriminator NN during training the generator NN and the discriminator NN.

8. The system of claim 1, wherein receiving the document comprises receiving an image of the document, and wherein, prior to scoring the similarities, executing the instructions further causes the system to:
extract a plurality of vector attributes for a template, a layout, and document data in the image; and
convert the image of the document to a vector based on the plurality of vector attributes,
wherein the vector is usable for scoring the similarities by scoring the vector to a plurality of other vectors for the plurality of preselected documents.

9. The system of claim 1, wherein, prior to scoring the similarities, the instructions further causes the system to:
perform an ML pattern analysis of the document using the ML model, wherein determining whether to flag the document using the decision engine is based on the ML pattern analysis and one or more of defined rules or thresholds for forgery pattern scores associated with the ML pattern analysis.

10. A method comprising:
receiving document training data for a generative artificial intelligence (AI) that generates fake documents from legitimate documents;
training a generator neural network (NN) and a discriminator NN using the document training data, wherein the generator NN generates the fake documents from the legitimate documents and document features identified in the legitimate documents, and wherein the discriminator NN provides feedback identifying whether each of the fake documents appears real or generated;
generating, using the generator NN of the generative AI after the training, additional fake documents for a machine learning (ML) model that performs fake document identification;
training the ML model using at least the additional fake documents; and
implementing the ML model with a decision engine for computations of document authenticity scores utilized for decisions on document forgery, wherein the computations are based on similarity scores between input documents and challenger documents including at least the additional fake documents.

11. The method of claim 10, further comprising:
receiving a document requested for a document verification;
processing the document by the decision engine using the ML model; and
outputting a decision on the document forgery of the document based on the processing.

12. The method of claim 11, wherein the decision comprises one of an approval, a rejection, or a request for resubmission of the document for the document verification.

13. The method of claim 10, wherein the document training data comprises legitimate document templates corresponding to the legitimate documents.

14. The method of claim 10, wherein the training the ML model includes:
reducing noise created by the at least the additional fake documents using anomaly scores associated with the generating the additional fake documents by the generator NN.

15. The method of claim 10, further comprising:
adding a watermark to the additional fake documents during the generating the additional fake documents,
wherein the watermark is used during the training the ML model to verify that the additional fake documents are untampered prior to the training.

16. The method of claim 15, further comprising:
encrypting the additional fake document with the watermark.

17. The method of claim 10, wherein prior to the training the generator NN and the discriminator NN, the method further comprises:
converting images of documents in the document training data to vectors,
wherein the vectors are used for the training the generator NN and the discriminator NN.

18. The method of claim 10, wherein the generator NN and the discriminator NN form a generative adversarial network (GAN), and wherein the GAN utilizes a Wasserstein GAN function for a loss minimization operation.

19. A non-transitory machine-readable medium having stored thereon machine-readable instructions executable to cause a machine to perform operations comprising:
accessing a document submitted to be verified;
processing, using a decision engine for forgery detection that includes a generative artificial intelligence (AI) model, the document for an indication of a forged portion;
determining, based on the processing, a plurality of similarities of the document to one or more of a real document or a fake document, wherein the fake document is generated by a generative adversarial network (GAN) that generates fake documents and distinguishes between the fake documents and real documents for the document verification;
determining whether the document includes the indication of the forged portion based on the similarities; and
outputting a decision on whether the document is verified based on whether the document includes the indication.

20. The non-transitory machine-readable medium of claim 19, wherein the operations further comprise:
scoring the similarities by the generative AI model,
wherein the determining whether the document includes the indication is further based on the scoring.
